(19) United States
(12) Patent Application Publication
(10) Pub. No.: US 2013/0034699 A1
(43) Pub. Date: Feb. 7, 2013

(54) BASE MATERIAL FOR MANUFACTURING HEAT DISSIPATER OF LIGHTING DEVICE

(71) Applicants: YU-YO CHIEN, New Taipei City (TW); YU-CHEN CHENG, New Taipei City (TW); CHEN-YI CHENG, New Taipei City (TW)

(72) Inventors: YU-YO CHIEN, New Taipei City (TW); YU-CHEN CHENG, New Taipei City (TW); CHEN-YI CHENG, New Taipei City (TW)

(21) Appl. No.: 13/197,786

(22) Filed: Aug. 4, 2011

(51) Int. Cl. B32B 3/30; B21C 23/00; B32B 3/02

(52) U.S. Cl. 428/157; 72/254

(57) ABSTRACT

Provided is a base material for manufacturing a heat dissipater of lighting device, which includes a board having opposite surfaces respectively forming a planar face section and a curved face section. The board forms a channel in an edge portion of the planar face section and also forms a pawl on an edge portion of the curved face section that is distant from the channel. Heat dissipation fins may obtain a desired configuration with the primary processing without additional processing applied to the external shape thereof, so that product passing rate can be improved. Further, cutting and shoveling operation applied to the fins allow the thickness of the fins to be reduced so that the number of the heat dissipation fins can be increased and the heat dissipation efficiency improved.

### (A) TECHNICAL FIELD OF THE INVENTION

The present invention generally relates to a base material of heat dissipater, and more particularly to a base material for manufacturing heat dissipater of lighting device, which base material can form a predetermined shape of heat dissipation fins after being machined without additional machining applied to an external portion thereof so that product passing rate can be enhanced and heat dissipation efficiency can be improved.

### (B) DESCRIPTION OF THE PRIOR ART

Referring to FIGS. 1 and 2, which respectively illustrate a conventional process for manufacturing a heat dissipater base material and an exploded view of the conventional heat dissipater base material, a conventional heat dissipater base material comprises a board 901, which has a rectangular cross-section, so that when being machined with a cutting and shoveling operation, heat dissipation fins 902 are formed in a rectangular configuration. When a light emission element 903 is mounted to a retention seat 904 of the heat dissipater, heat generated by the light emission element 93 can be dissipated through the heat dissipation fins 902.

It is noted that the above described conventional heat dissipater base material shows certain drawbacks, of which some are listed below, when put into use, and such drawbacks must be improved.

(1) Since the heat dissipation fins 902 are of a small thickness and are thus easily deformable. To make the outer configuration of the heat dissipation fins 902 a more interesting shape, a secondary machining operation is required. This often leads to undesired deformation of the heat dissipation fins 902 and reduction of product passing rate.

(2) To eliminate the problem of inducing undesired deformation, the conventional heat dissipater base material is often structured to have an increased thickness of the heat dissipation fins 902. This leads to reduced of heat dissipation efficiency and thus, wattage of the light emission element 903 is subjected to undesired constraint.

### SUMMARY OF THE INVENTION

The primary objective of the present invention is to provide a solution that overcomes the problems that the heat dissipation fins of a conventional heat dissipater base material are thin and easy to deform and that secondary processing is required in order to change the outside shape of the heat dissipation fins for providing an interesting configuration, this leading to underside deformation and reduction of product passing rate, whereby the present invention allows heat dissipation fins to shows a desired configuration with the primary processing without additional processing applied to the external shape thereof, so that product passing rate can be improved.

To achieve the above objective, the present invention provides a base material for manufacturing heat dissipater of lighting device, which comprises a board, which has two opposite surfaces respectively forming a planar face section and a curved face section. The board forms a channel in an edge portion of the planar face section. The board forms a pawl on an edge portion of the curved face section that is distant from the edge where the channel is formed. The board is formed through extrusion with a molding device. The molding device forms a molding cavity. The molding device comprises a flat section that is formed on one side of the molding cavity. An opposite side of the molding cavity forms an inclined curve section. The molding device forms a first raised section at one end adjacent to the inclined curve section. The molding device forms a second raised section at and end that is adjacent to the planar face section and is distant from the first raised section.

The board is bent to form a deflected and curved configuration of the board. The heat dissipation fins form at one end thereof a retention groove that is formed by cutting and shoveling the channel of the board. The heat dissipation fins form a retention hook that is formed by cutting and shoveling the pawl of the board. The heat dissipation fins are arranged in a radiating form. The deflected and curved configuration of the board forms an inner wall. The inner wall has opposite ends that respectively form a first coupling section that couples a light emission element and a second coupling section that couples a light base.

The deflected and curved configuration of the board is manufactured through the following steps:

(a) providing molding device for carrying out aluminum extrusion;

(b) employing the molding device to extrude and form a board;

(c) cutting and shoveling the board to form parallel heat dissipation fins, the heat dissipation fins being connected to each other by a retention seat formed on the board; and

(d) bending the board to form a deflected and curved configuration so that opposite ends of the board respectively form a first coupling section and a second coupling section.

With the above described structure and operation, a secondary objective of the present invention may also be realized, which overcomes the problems that the conventional heat dissipater base material often adopted increased thickness of the heat dissipation fins in order to prevent undesired deformed caused by the secondary processing and thus leading to poor heat dissipation efficiency, so that wattage of a light emission element is subjected to undesired constraint, whereby the present invention helps increasing the heat dissipation efficiency.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 illustrates a conventional process for manufacturing a heat dissipater base material.

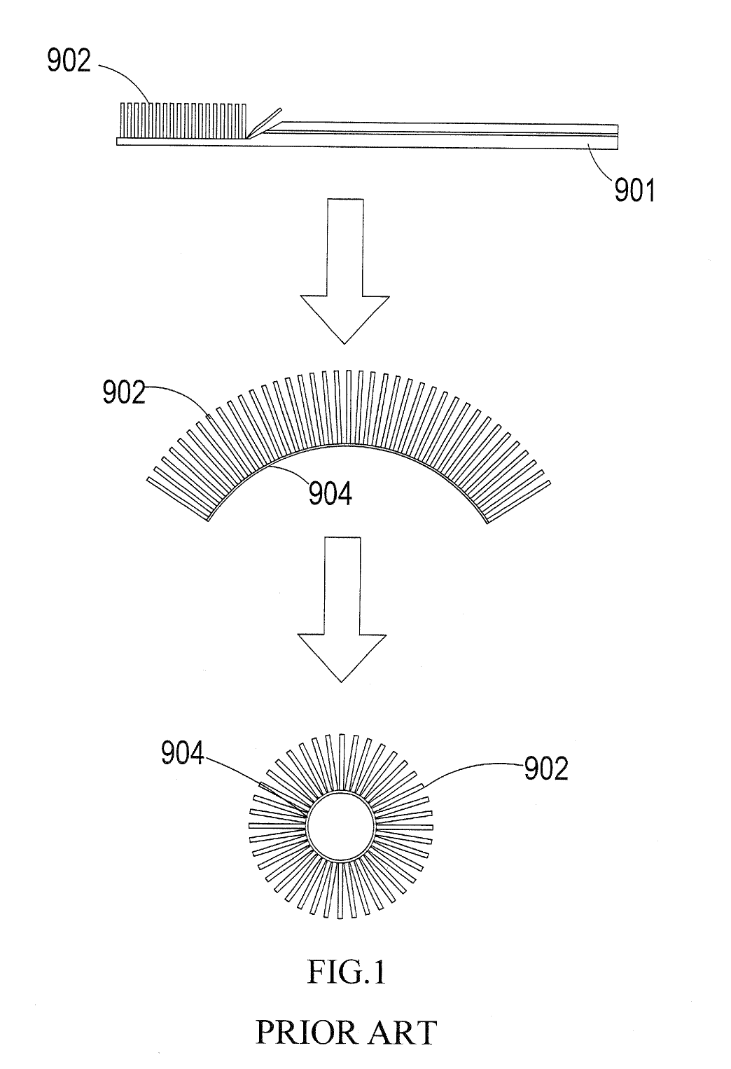

FIG. 2 is an exploded view of the conventional heat dissipater base material.

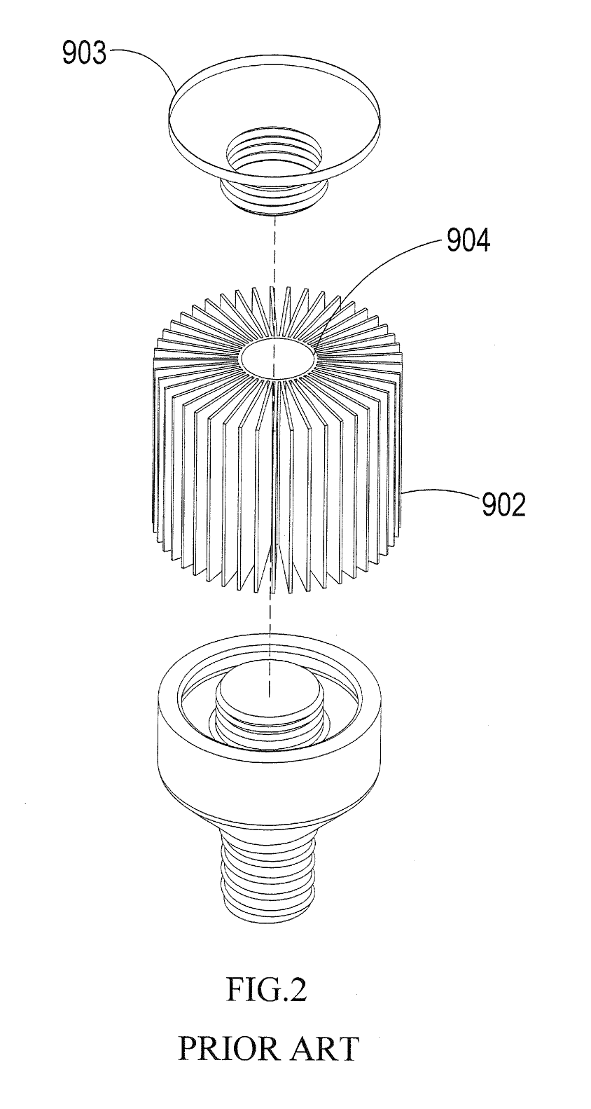

FIG. 3 is a perspective view of a board that serves as a base material according to the present invention.

FIG. 4 is a schematic cross-sectional view of mold employed in the present invention for molding the base material.

FIG. 5 illustrates a cutting and shoveling process for processing the base material according to the present invention.

FIG. 6 is a schematic view of heat dissipation fin according to the present invention.

FIG. 7 is a perspective view of an assembled lighting device including a heat dissipater according to the present invention.

FIG. 8 is an exploded view of the lighting device according to the present invention.

FIG. 9 is a cross-sectional view of the lighting device according to the present invention.

FIG. 10 is a flow chart of a manufacturing process according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

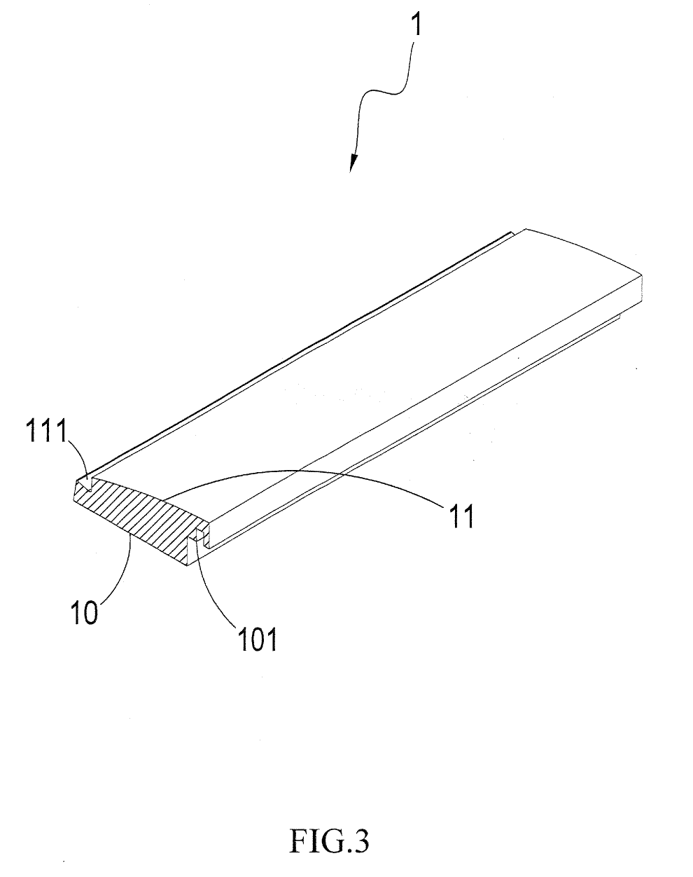

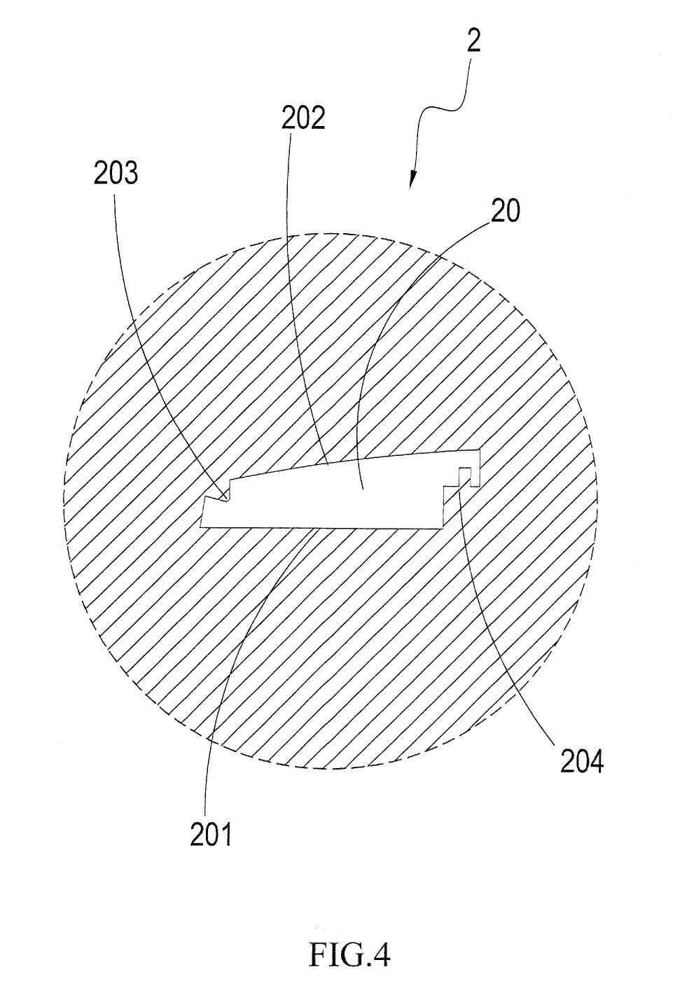

The present invention will now be described with reference to a preferred embodiment thereof Reference is first made to FIGS. 3 and 4, which are respectively a perspective view of a board that serves as a base material according to the present invention and a schematic cross-sectional view of mold employed in the present invention for molding the base material. The drawings clearly show that the base material for manufacturing a heat dissipater in accordance with the present invention comprises the board, which is generally designated at 1. The board 1 has two opposite surfaces, which respectively form a planar face section 10 and a curved face section 11. The board 1 forms a channel 101 in an edge portion of the planar face section 10; and the board 1 also forms a pawl 111 on an edge portion of the curved face section 11 that is distant from the edge where the channel 101 is formed. The board 1 is formed through extrusion with a molding device 2. The molding device 2 forms a molding cavity 20. The molding device 2 comprises a flat section 201 that is formed on one side of the molding cavity 20; and an opposite side of the molding cavity 20 forms an inclined curve section 202. The molding device 2 forms a first raised section 203 at one end adjacent to the inclined curve section 202; and the molding device 2 also forms a second raised section 204 at and end that is adjacent to the planar face section 201 and is distant from the first raised section 203.

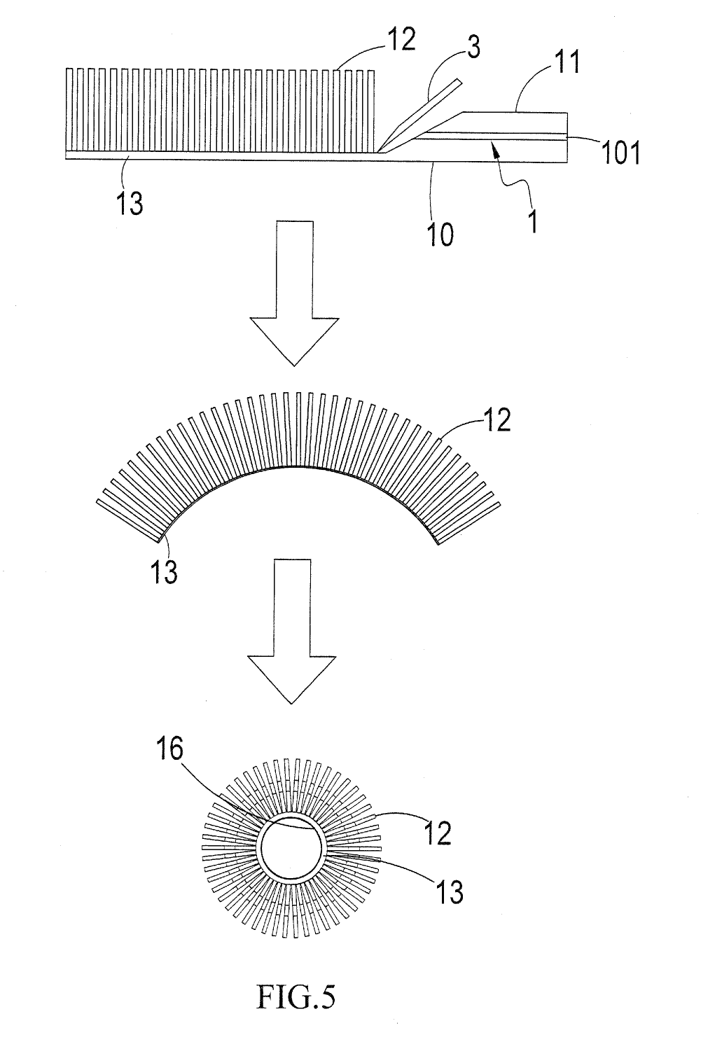

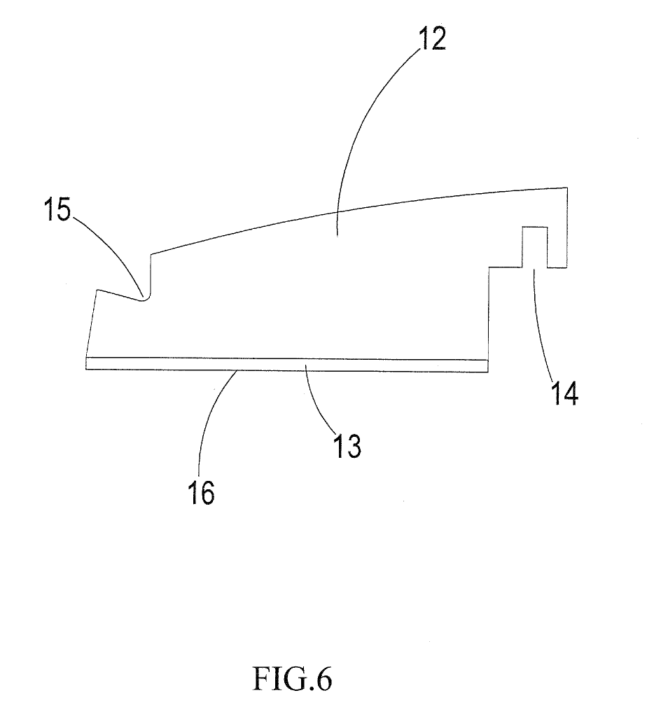

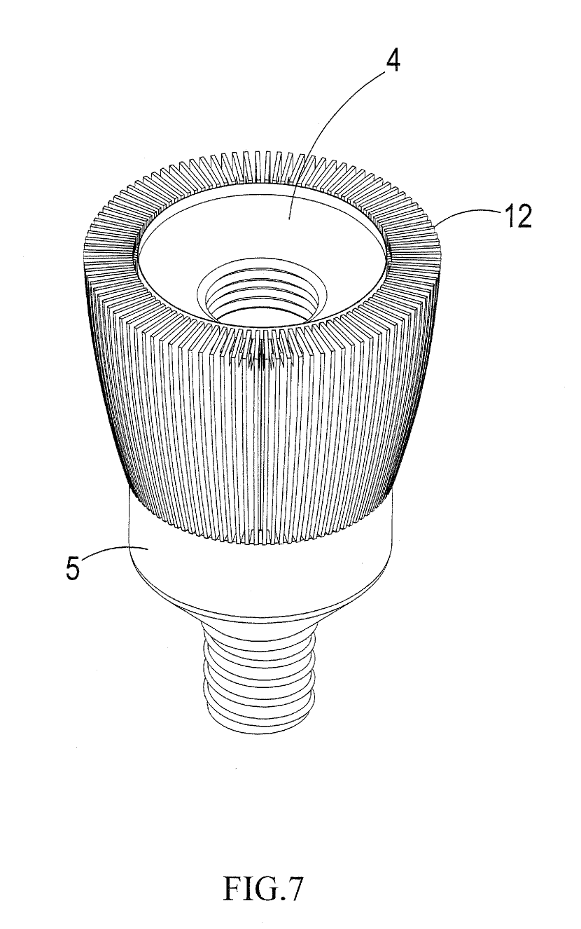

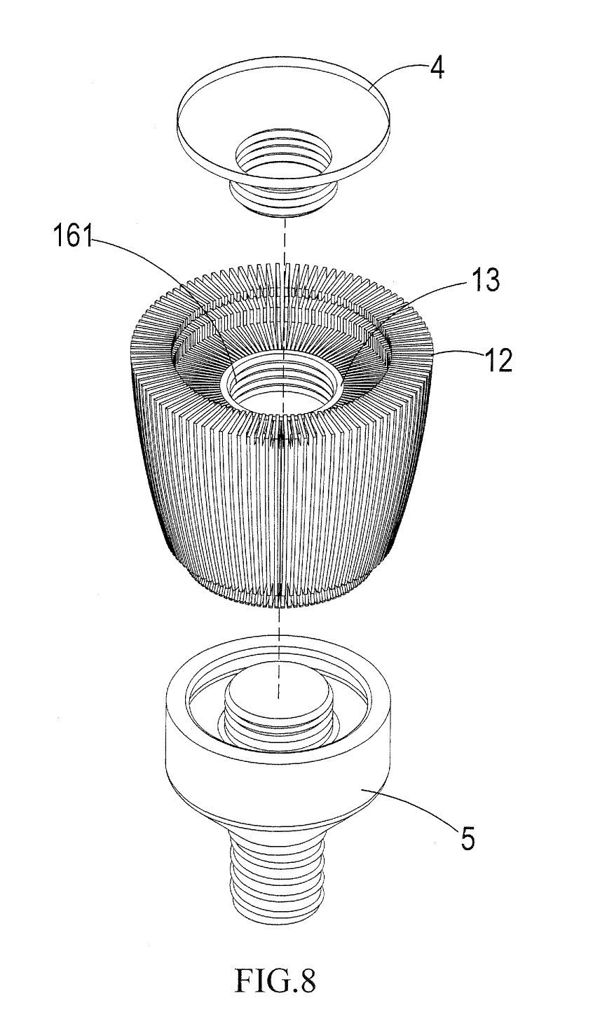

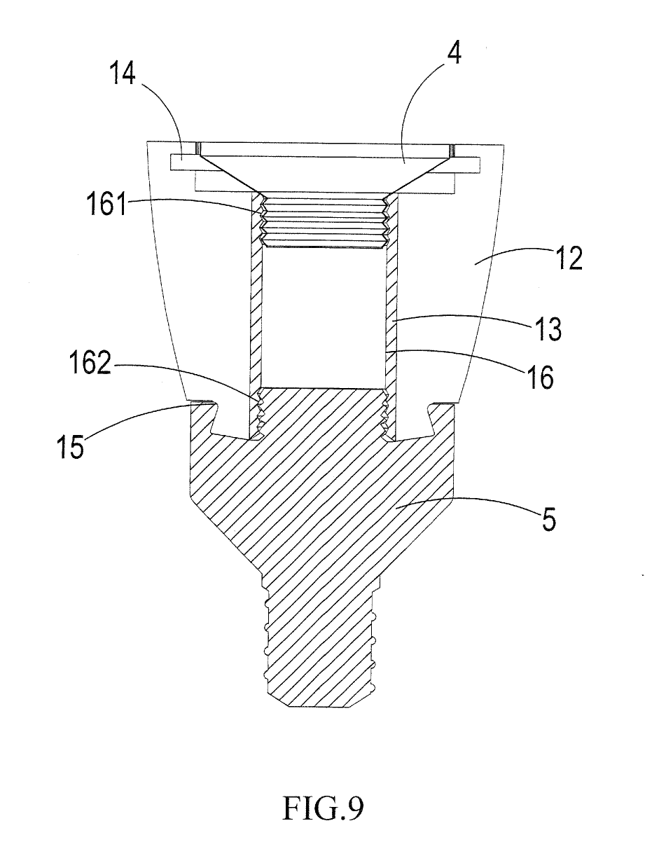

Referring to FIGS. 3, 5, 6, 7, 8, and 9, which are respectively a perspective view of a board that serves as a base material according to the present invention, a cutting and shoveling process for processing the base material, a schematic view of heat dissipation fin, a perspective view of an assembled lighting device including a heat dissipater, an exploded view of the lighting device, and a cross-sectional view of the lighting device, these drawings clearly show that the board 1 is processed by using a cutter 3 to cut and shovel the curved face section 11 in order to form at least one heat dissipation fin 12, multiple fins being shown in the drawings. The board 1 forms a retention seat 13 with the planar face section 10 in order to connect together the heat dissipation fins 12. The heat dissipation fins 12 form at one end thereof a retention groove 14 that is formed by cutting and shoveling the channel 101 of the board 1. The heat dissipation fins 12 also form a retention hook 15 that is formed by cutting and shoveling the pawl 111 of the board 1. Afterwards, the board 1 is bent to form a deflected and curved configuration of the board 1 with the heat dissipation fins 12 being in a radiating form. The deflected and curved configuration of the board 1 forms an inner wall 16.

The inner wall 16 has opposite ends that respectively form a first coupling section 161 that couples a light emission element 4 and a second coupling section 162 that couples a light base 5. The heat dissipation fins 12 that are formed through the cutting and shoveling operation require no secondary machining operation so that the thickness of the fins so cut and shoveled can be reduced, whereby the number of the heat dissipation fins 12 can be increased and the heat dissipation efficiency improved. Experiments indicate that the heat dissipation efficiency of the heat dissipater according to the present invention is approximately 30-40% higher than that of the conventional heat dissipaters and thus it allows use of a light emission element 4 having wattage higher than the conventional ones.

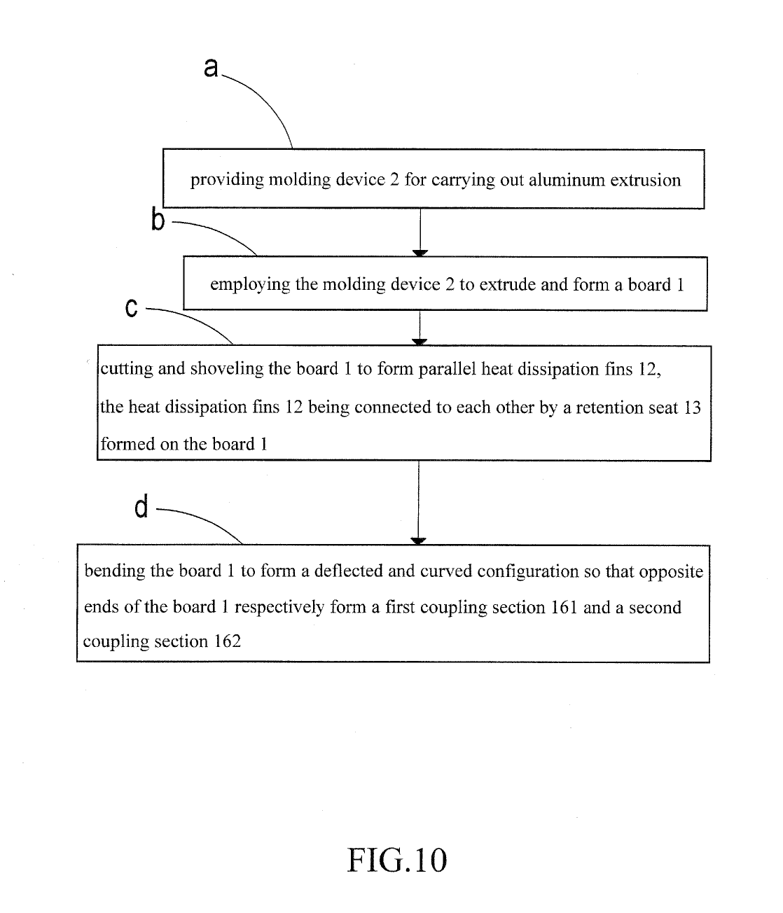

Referring to FIGS. 3, 4, 5, 8, and 10, which are respectively a perspective view of a board that serves as a base material according to the present invention, a schematic cross-sectional view of mold employed in the present invention for molding the base material, a cutting and shoveling process for processing the base material, an exploded view of a lighting device including a heat dissipater, and a flow chart of a manufacturing process according to the present invention, these drawings clearly show that the deflected and curved configuration of the board is manufactured through the following steps:

(a) providing molding device 2 for carrying out aluminum extrusion;

(b) employing the molding device 2 to extrude and form a board 1;

(c) cutting and shoveling the board 1 to form parallel heat dissipation fins 12, the heat dissipation fins 12 being connected to each other by a retention seat 13 formed on the board 1;

(d) bending the board 1 to form a deflected and curved configuration so that opposite ends of the board 1 respectively form a first coupling section 161 and a second coupling section 162.

With the above described embodiment, the application and use of the present invention, as compared to the conventional techniques, provide the following advantages:

(1) The heat dissipation fins 12 according to the present invention show an outer configuration that is formed at the step of forming the board 1 with the molding device 2, so that secondary processing can be omitted and the product passing rate is improved.

(2) The omission of the secondary processing allows reduction of manufacturing steps and consumption of resources.

(3) The curved heat dissipation fins 12 provide improved heat dissipation performance as compared to the conventional rectangular heat dissipation fins 902.

(4) The heat dissipation fins 12 are formed with the cutting and shoveling operation and do not require secondary processing, so that the thickness that the fins formed through cutting and shoveling can be reduced, whereby the number of the heat dissipation fins 12 can be increased and the heat dissipation efficiency improved. Experiments indicate that the heat dissipation efficiency of the heat dissipater according to the present invention is approximately 30-40% higher than that of the conventional heat dissipaters and thus it allows use of a light emission element 4 having wattage higher than the conventional ones.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A base material for manufacturing heat dissipater of lighting device, comprising a board, which has two surfaces respectively forming a planar face section and a curved face section, the board forming a channel in an edge portion of the planar face section, the board also forming a pawl on an edge portion of the curved face section that is distant from the channel.

2. The base material for manufacturing heat dissipater of lighting device according to claim 1, wherein the board is formed through extrusion with a molding device.

3. The base material for manufacturing heat dissipater of lighting device according to claim 2, wherein the molding device forms a molding cavity, the molding device comprising a flat section that is formed on one side of the molding cavity, an opposite side of the molding cavity forming an inclined curve section, the molding device forming a first raised section at one end adjacent to the inclined curve section, the molding device forming a second raised section at and end that is adjacent to the planar face section and is distant from the first raised section.

4. The base material for manufacturing heat dissipater of lighting device according to claim 1, wherein the board is processed by using a cutter to cut and shovel the curved face section in order to form at least one heat dissipation fin, The board forming a retention seat with the planar face section in order to connect the heat dissipation fins, the heat dissipation fin forming at one end thereof a retention groove that is formed by cutting and shoveling the channel of the board, the heat dissipation fin forming a retention hook that is formed by cutting and shoveling the pawl of the board.

5. The base material for manufacturing heat dissipater of lighting device according to claim 4, wherein the board is bent to form a deflected and curved configuration of the board with the heat dissipation fin being in a radiating form.

6. The base material for manufacturing heat dissipater of lighting device according to claim 5, wherein the deflected and curved configuration of the board forms an inner wall, the inner wall having opposite ends that respectively form a first coupling section adapted to couple a light emission element and a second coupling section adapted to couple a light base.

7. The base material for manufacturing heat dissipater of lighting device according to claim 5, wherein the deflected and curved configuration of the board is manufactured through the following steps:
(a) providing molding device for carrying out aluminum extrusion;
(b) employing the molding device to extrude and form a board;
(c) cutting and shoveling the board to form parallel heat dissipation fins, the heat dissipation fins being connected to each other by a retention seat formed on the board; and
(d) bending the board to form a deflected and curved configuration so that opposite ends of the board respectively form a first coupling section and a second coupling section.
